(19) United States
(12) Patent Application Publication
(10) Pub. No.: US 2013/0224328 A1
(43) Pub. Date: Aug. 29, 2013

(54) DEMOLDING MECHANISM FOR MOLDED ARTICLE HAVING INTERNAL THREAD

(71) Applicants: XIAN-YAN FANG, Shenzhen (CN); JIN-XIN SUN, Shenzhen (CN); DE-JUN ZHU, Shenzhen (CN); CHUN-CHE YEN, New Taipei (TW); FENG-HSING HSIEH, New Taipei (TW)

(72) Inventors: XIAN-YAN FANG, Shenzhen (CN); JIN-XIN SUN, Shenzhen (CN); DE-JUN ZHU, Shenzhen (CN); CHUN-CHE YEN, New Taipei (TW); FENG-HSING HSIEH, New Taipei (TW)

(21) Appl. No.: 13/681,431

(22) Filed: Nov. 20, 2012

(30) Foreign Application Priority Data
Feb. 23, 2012 (CN) 201210041832.9

(51) Int. Cl. B29C 45/40

(52) U.S. Cl. CPC B29C 45/4005
USPC 425/556

(57) ABSTRACT

A demolding mechanism for demolding a molded article with internal thread is provided. The demolding mechanism includes an outer sleeve and a core. The sleeve includes a number of spring legs and a body. Each spring leg has an external thread. The core includes an end portion and a cylindrical shank. The end portion includes a central portion and a number of evenly spaced ribs. The diameter of the core is smaller than that of the sleeve. The sleeve is slidable along the core. When the spring legs move away and disengage from the ribs, the spring legs are configured to deflect inwardly, thereby enabling the external thread thereof to disengage from the inner thread of the molded article.

### BACKGROUND

1. Technical Field

The present disclosure relates to a demolding mechanism for molded article having internal thread.

2. Description of Related Art

Molded articles having internal thread for electronic device are commonly used. During one demolding process of the articles, a motor is employed for driving the gears and/or a screw to rotate via a strap or a chain, so as to demold the article. However, the molds for use with such demolding mechanisms (i.e., the motor, the gears, and the strap or chain) are complex in structure. Furthermore, complex molds are very expensive for articles of small size, such as lamps having an internal thread, bottle flanges, rotary buttons and the like.

A demolding mechanism is needed for molded article having internal thread which has simple structure and lower cost to overcome the limitations described above.

### BRIEF DESCRIPTION OF THE DRAWINGS

The components in the drawings are not necessarily drawn to scale, the emphasis instead being placed upon clearly illustrating the principles of this disclosure. Moreover, in the drawings, like reference numerals designate corresponding parts throughout the several views.

FIG. 1 is an assembled view of an exemplary embodiment of a demolding mechanism, a female mold, and a male mold.

FIG. 2 is a cross-sectional view of the assembly of FIG. 1.

FIG. 3 is an exploded view of the assembly of FIG. 1.

FIG. 4 is an isometric view of the male mold of FIG. 1.

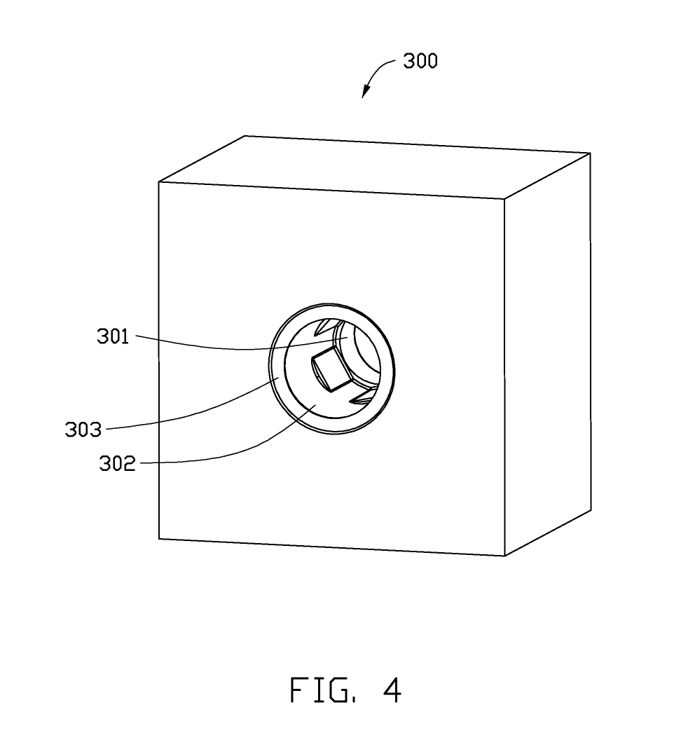

FIG. 5 is a schematic view of the demolding process of the article.

FIG. 6 is an isometric view of the article.

FIG. 7 is another isometric view of the article, viewed from another perspective.

FIG. 8 is an isometric view of the demolding mechanism of FIG. 1.

FIG. 9 is an isometric view of the demolding mechanism and the article engaged with each other.

FIG. 10 is an exploded view of the demolding mechanism and the article of FIG. 9.

### DETAILED DESCRIPTION

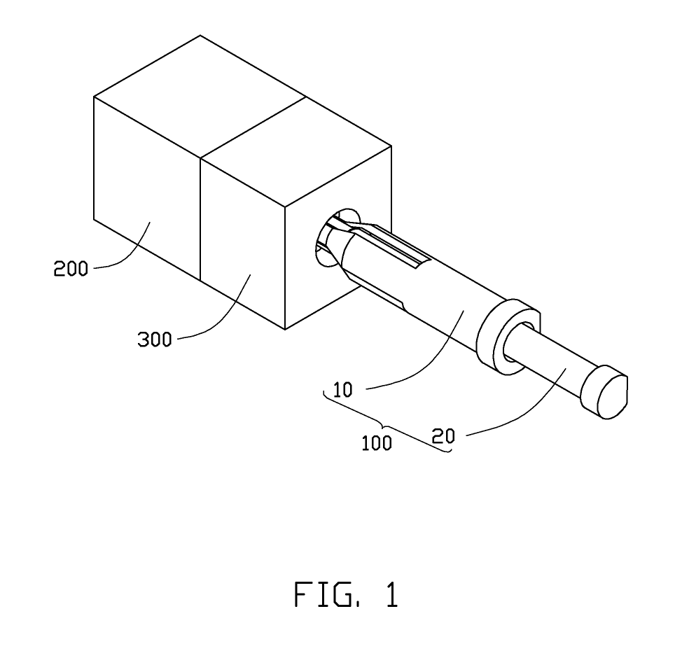

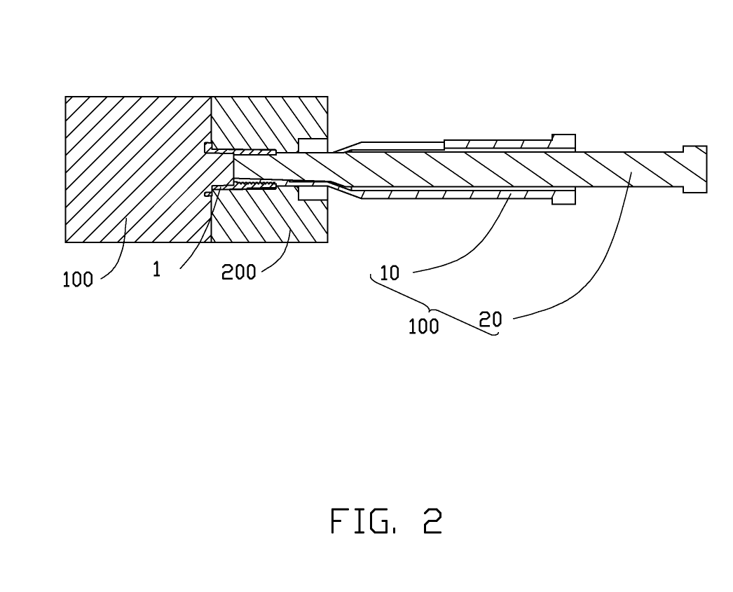

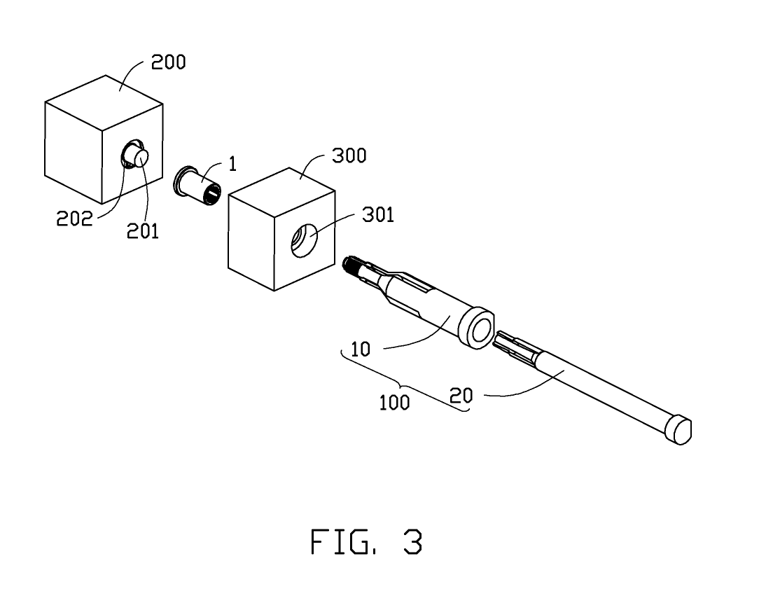

FIG. 1 is an assembled view of an exemplary embodiment of a mold for forming a molded article 1 (shown in FIGS. 2 and 3) having an internal thread. The mold includes a female mold 200, a male mold 300, and a demolding mechanism 100. In use, after the process of molding, the female mold 200 is firstly separated from the male mold 300, and then the article 1 is removed from the male mold 300 by the demolding mechanism 100.

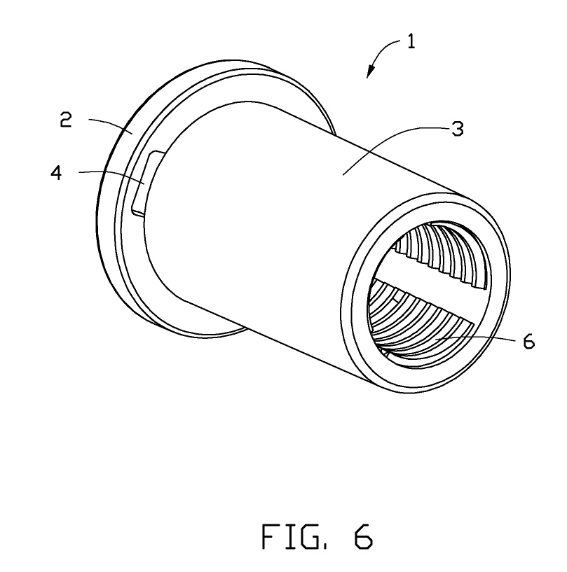

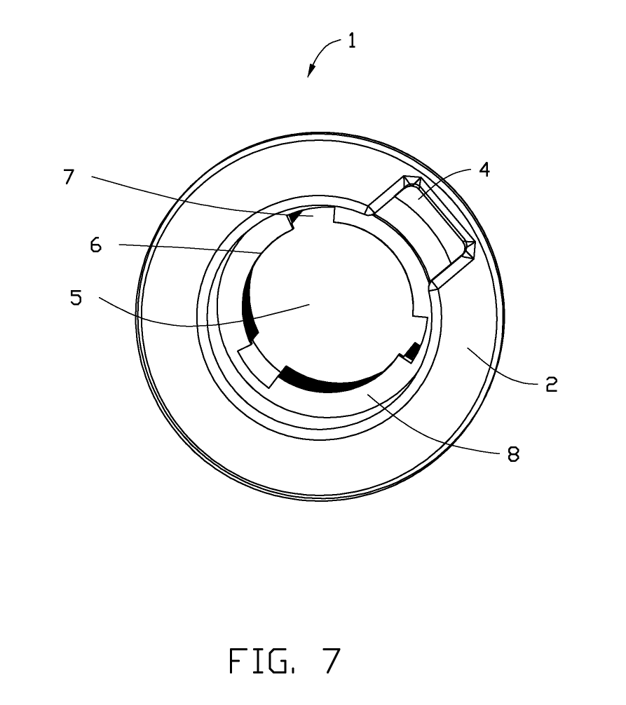

FIGS. 6 and 7 are isometric views of the article 1 from different perspectives. The article 1 includes a base 2 and an engagement portion 3 protruding from the base 2. The base 2 is round and defines an opening 4. The engagement portion 3 is cylindrical and defines a circular through hole 5. The inner wall of the through hole 5 has an internal thread 6 and defines a number of sliding grooves 7. In the embodiment, the number of the sliding grooves 7 are three, and the sliding grooves 7 are evenly spaced from each other, thus dividing the internal thread 6 into three sections. The through hole 5 includes a first hole portion and a second hole portion. The first hole portion is close to the base 2 and has a diameter equal to the inner diameter of the base 2. The second hole portion is distanced from the base 2 and has a diameter smaller than the inner diameter of the base 2. Thus a step 8 is formed between the first hole portion and the second hole portion. In other embodiments, the number of the sliding grooves 7 can vary according to need.

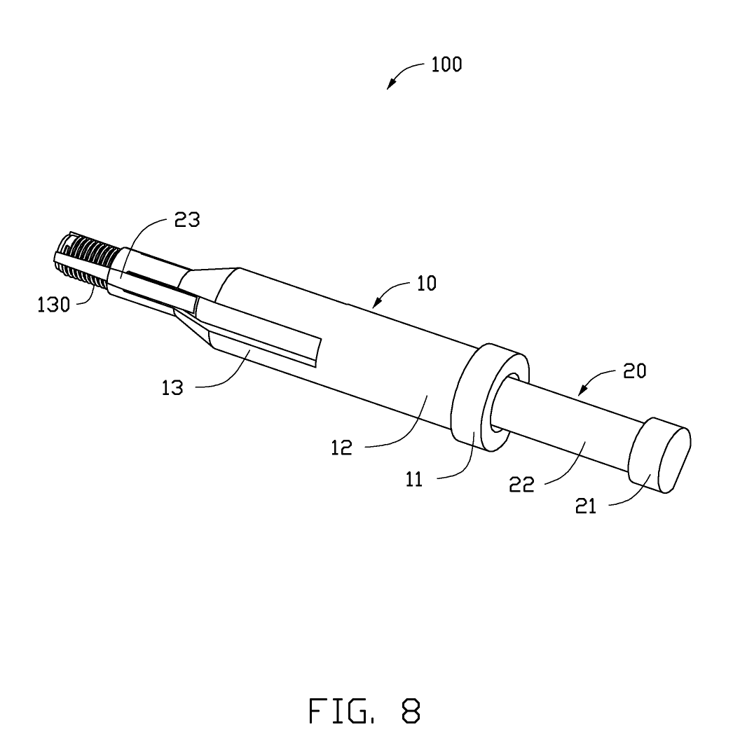

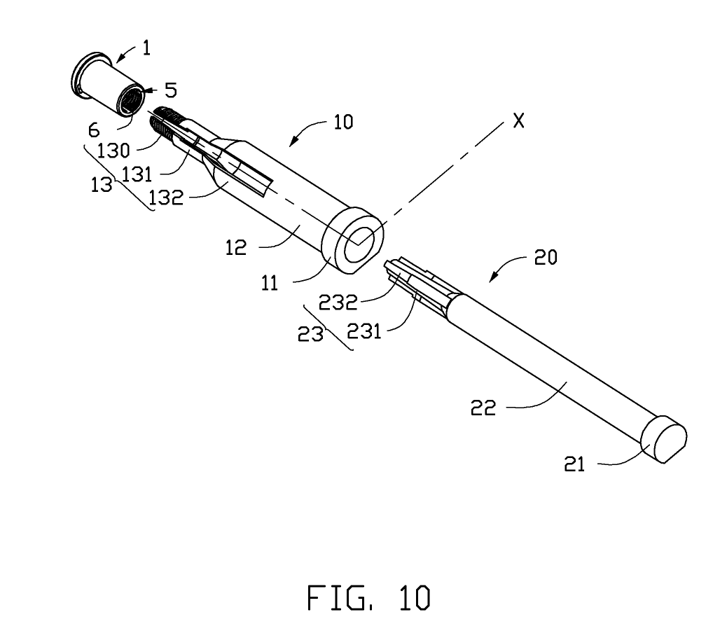

Referring to FIGS. 8-10, the demolding mechanism 100 includes a sleeve 10 and a core 20. The sleeve 10 is slidably sleeved on the core 20. The sleeve 10 includes a flange 11, a number of legs 13 and a body 12 connecting the flange 11 with the legs 13. The number of legs 13 is equal to the number of the sliding grooves 7. The flange 11 is cylindrical and has an outer diameter greater than the outer diameter of the body 12. The body 12 is a cylinder and has an inner diameter equal to the inner diameter of the flange 11. The legs 13 protrude from one end of the body 12, and are evenly spaced from each other. The legs 13 are elastically deformable. Each leg 13 has an external thread 130 on the end away from the flange 11. The external thread 130 forms the internal thread 6 of the article 1. Each leg 13 further includes a connection portion 132 connecting the body 12 and a middle portion 131. The external radius of the connection portion 132 is greater than the external radius of the middle portion 131. The outer diameter of the externally-threaded end of each leg 13 is smaller than the outer diameter of the middle portion 131.

The core 20 is a cylinder and includes a head 21, an end portion 23, and a shank 22 connecting the head 21 and the end portion 23. The head 21 has a substantially D-shaped cross-section. The shank 22 is a cylinder and has a diameter smaller than the diameter of the flange 11. The diameter of the shank 22 is slightly smaller than the inner diameter of the body 12. The end portion 23 includes a central portion 231 and a number of elongated ribs 232 evenly spaced from each other and protruding from the central portion 231. Each rib 232 is received between two legs 13. The number of the elongated ribs 232 is equal to the number of the sliding grooves 7. The central portion 231 and the shank 22 are coaxial. The diameter of the central portion 231 is smaller than the diameter of the shank 22.

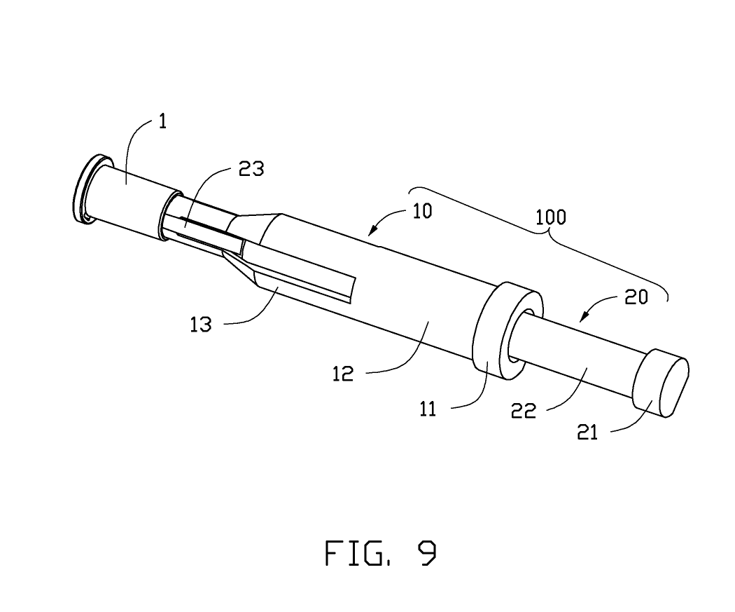

As shown in FIG. 8, the distal end of the leg 13 and the distal end of the end portion 23 are flush with each other. FIG. 9 is an isometric view of the demolding mechanism 100 and the article 1 engaged with each other. The external thread 130 of the leg 13 is engaged with the inner thread 6 of the article 1, and both the external thread 130 and the end portion 23 are received in the through hole 5 (not shown).

Referring to FIGS. 1-3, the female mold 200 has a cavity insert 201 protruding from a first cavity 202 of the female mold 200. The male mold 300 defines a through hole 301 for receiving the front end of the cavity insert 201, and an end of the end portion 23. As shown in FIG. 2, after the assembly together of the female mold 200, the male mold 300 and the demolding mechanism, a mold cavity is formed and molten plastic or other material can be injected into the mold cavity to form the article 1. The male mold 300 defines a necking 302. In this embodiment, the necking 302 is circular and the external thread 130 and middle portions 131 of the legs 13 can pass through it. The external radius of the connection portion 132 is greater than the radius of the necking 302, thus the connection portion 132 cannot pass through the necking 302.

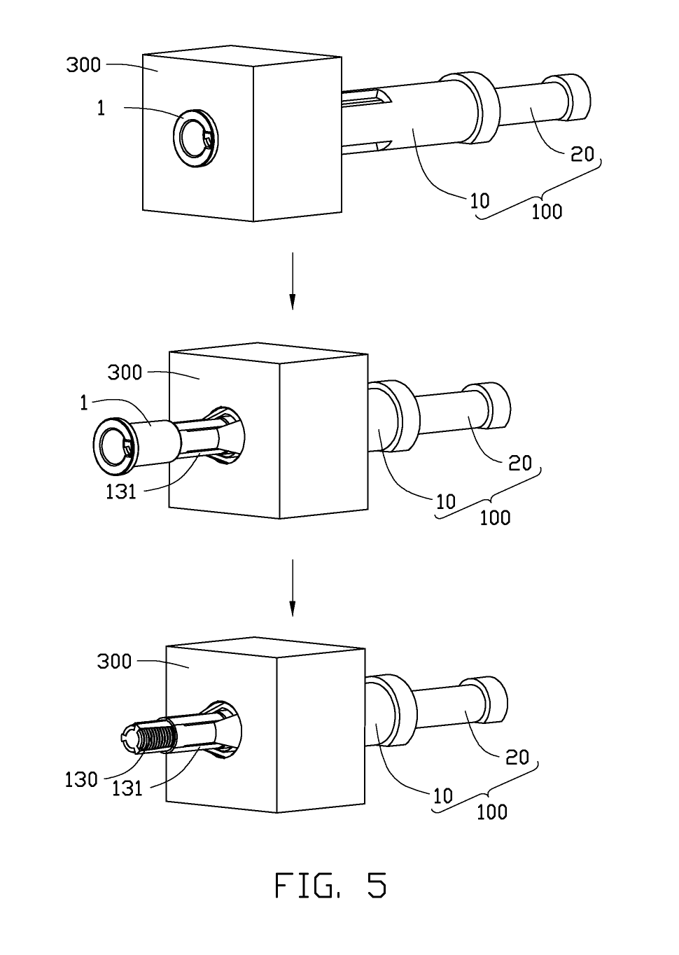

Referring to FIGS. 2 and 5, when demolding, firstly, the female mold 200 is separated from the male mold 300, shown as the first image of FIG. 5. The core 20 and the male mold 300 are fixed by an auxiliary tool, to render a fixed relativity between them. The article 1 and the sleeve 10 are pushed to slide away from the core 20 along the through hole 301 of the male mold 300, until the article 1 moves out of the male mold 300 completely (second image of FIG. 5). The external thread 130 of the legs 13 are engaged with the article 1, and both the external thread 130 and the middle portion 131 have passed through the necking 302 and extend out of the male mold 300. The end portions 23 are received in the connection portion 132 of the legs 13. Then, the sleeve 10 is further pushed to slide away from the core 20 along the through hole 301. The connection portion 132 cannot pass through the necking 302 because of the smaller semi-diameter of the necking 302. When the legs 13 move away and disengage from the ribs 232, the end where the external thread 130 is formed and the middle portions 131, as a whole, deflect elastically inwardly due to the force passed by the sleeve 10, thereby enabling the inner thread 6 of the article 1 to disengage from the external thread 130 of the legs 13. The article 1 can then be removed from the demolding mechanism 100.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A demolding mechanism for demolding a molded article with inner thread, the demolding mechanism comprising:
a sleeve comprising:
a plurality of spring legs, one end of each leg comprising an external thread; and
a hollow cylindrical sleeve body connected to the plurality of spring legs; and
a core comprising:
an end portion comprising a central portion and a plurality of ribs evenly spaced from each other, protruding from the central portion, and each of which is received between two of the spring legs; and
a cylindrical shank connected to the end portion, the shank having a diameter smaller than a diameter of the sleeve body;
wherein the sleeve is unidirectionally and slidably sleeved on the core, a distal end of each spring leg and a distal end of the end portion are flush with each other, the sleeve is slidable along the core, and when the spring legs move away and disengage from the ribs, the spring legs are configured to deflect inwardly, thereby enabling the external thread thereof to disengage from the inner thread of the molded article.

2. The demolding mechanism as described in claim 1, wherein each of the spring leg further comprises a connection portion connecting the sleeve body and a middle portion, the external radius of the connection portion is greater than the external radius of the middle portion, the outer diameter of the externally-threaded end of each spring leg is smaller than the outer diameter of the middle portion.

3. The demolding mechanism as described in claim 1, wherein the central portion and the shank are coaxial, and the diameter of the central portion is smaller than the diameter of the shank.

4. The demolding mechanism as described in claim 1, wherein the sleeve further comprises a cylindrical flange, and the sleeve body connects the flange with the plurality of spring legs.

5. The demolding mechanism as described in claim 4, wherein the external thread is located on the end of each spring leg away from the flange.

6. The demolding mechanism as described in claim 4, wherein the outer diameter of the flange is greater than the outer diameter of the sleeve body, and the inner diameter of the flange is equal to the inner diameter of the sleeve body.

7. The demolding mechanism as described in claim 1, wherein the core further comprises a head having a substantially D-shaped cross-section, and the shank connects the head with the end portion.

8. The demolding mechanism as described in claim 1, wherein the plurality of spring legs are elastically deformable and are evenly spaced from each other.
